(19) United States
(12) Patent Application Publication
(10) Pub. No.: US 2016/0258460 A1
(43) Pub. Date: Sep. 8, 2016

(54) TOLERANCE COMPENSATION COMPONENT FOR TOLERANCE COMPENSATION WHEN JOINING TOGETHER STRUCTURAL ELEMENTS

(71) Applicant: Airbus Operations GmbH, Hamburg (DE)

(72) Inventor: Leonid Gorodinsky, Bremen (DE)

(73) Assignee: AIRBUS OPERATIONS GMBH, Hamburg (DE)

(21) Appl. No.: 14/854,167

(22) Filed: Sep. 15, 2015

(30) Foreign Application Priority Data
Sep. 17, 2014 (DE) 10 2014 113 440.0

(51) Int. Cl. F16B 5/02

(52) U.S. Cl. CPC F16B 5/025

(57) ABSTRACT

A tolerance compensation component for tolerance compensation when joining together two structural elements includes a retaining element, an outer component, and an inner component. The retaining element exhibits a recess. The outer component is situated in the recess of the retaining element. The outer component exhibits a recess arranged eccentrically relative to the midpoint of the outer component. The inner component is in turn situated in the recess of the outer component. The inner component also exhibits a recess arranged eccentrically relative to the midpoint of the inner component. The circumference of the recess of the retaining element and/or the circumference of the recess of the outer component exhibit essentially half-round notches. The outer and/or inner component exhibits essentially round notches, which are arranged essentially in a circular arc on the outer and/or inner component.

### FIELD OF THE INVENTION

The invention relates to a tolerance compensation component for tolerance compensation when joining together two or more structural elements, a device for tolerance compensation when joining together the structural elements, an aircraft or spacecraft with such a tolerance compensation component, as well as an assembly method for such a tolerance compensation component.

### BACKGROUND OF THE INVENTION

EP 1 411 219 B1 discloses a connection and adjustment device for two structural elements to be joined together. A double eccentric for tolerance compensation is fastened in an adjusting ring gap. A clamping device envelops the device in the area of the double eccentric. A tensioning device produces a radial restraint or clamp connection between the two structural elements to be joined together, while inserting the double eccentric with a fixation of the relative angular position between the outer eccentric ring and inner eccentric ring.

However, the function of such a clamp connection depends heavily on the conditions of use, e.g., on the surface characteristics of the structural elements to be joined together, on the presence of dirt and oil, but also on the temperature of use or a change in the temperature of use. Therefore, such a connection and adjustment device with a double eccentric and a clamp connection is little suited for conditions of use associated with high loads and/or stringent safety requirements.

### BRIEF SUMMARY OF THE INVENTION

Therefore, an aspect of the invention provides a tolerance compensation component that hardly depends on the conditions of use any longer.

An embodiment of the invention comprises a tolerance compensation component for tolerance compensation when connecting two structural elements, a device for tolerance compensation when connecting two structural elements, an aircraft or spacecraft with such a tolerance compensation component, as well as an assembly method for such a tolerance compensation component.

It is proposed that a tolerance compensation component for tolerance compensation when connecting two structural elements be provided. The tolerance compensation component encompasses a retaining element, an outer component and an inner component.

The retaining element exhibits a recess. The outer component is situated in the recess of the retaining element. The outer component exhibits a recess arranged eccentrically relative to the midpoint of the outer component. The inner component is in turn situated in the recess of the outer component. The inner component also exhibits a recess arranged eccentrically relative to the midpoint of the inner component. The recesses can be circular through or blind holes.

The circumference of the recess of the retaining element and/or the circumference of the recess of the outer component essentially exhibit half-round notches. The outer and/or inner component essentially exhibit round notches, which are essentially arranged in a circular arc on the inner and/or outer component. The notches can be holes and in particular through holes. Blind holes are also possible in part.

In other words, the tolerance compensation component or tolerance compensation knot exhibits a double eccentricity, and can thereby enable a tolerance compensation between at least two structural elements or connecting pieces to be joined together or connecting points. The tolerance compensation component can also be used to set or finely adjust the structural elements to be joined together, e.g., to adjust the radius, angle, position, etc.

The desired arrangement of structural elements is fixed in place with the half-round and round notches. The half-round and round notches are used to positively connect the structural elements to be joined together. By comparison to a frictional connection, such a positive connection no longer depends on the conditions of use. The surface characteristics of the structural elements to be joined together, the presence of dirt and oil, the temperature of use or changes therein are hardly relevant any longer. In addition, the positive connection is more precise by comparison to a frictional connection. The half-round and round notches preclude any inadvertent change in the arrangement of the positive connection.

Such a tolerance compensation component can be universally used to assemble or fasten two or more immovable or movable structural elements or mechanical components. The structural elements can stem from the area of aerospace, shipbuilding, plant engineering, general engineering, etc. The structural elements can be scaffolds, frameworks, carriers, etc.

The tolerance compensation component is especially suitable for conditions of use involving high loads and/or stringent safety requirements. The tolerance compensation component can transmit radial loads, axial loads and/or torsion loads. The tolerance compensation component can be used as often as desired, without one or more of its machine elements having to be replaced for the next application. There is no requirement for disposable consumables, e.g., lock wires, lock plates or safety splints.

For example, a passenger plane can be equipped with a removable, segmented scaffold for transporting pallets, wherein the scaffold is fastened by means of attachment bolts to predefined lashing points in the cargo hold. The tolerance compensation components here allow the attachment bolts at the lashing points to hit the respective center of the boreholes very precisely, for example, so that the boreholes can only be slightly larger than the bolt diameter. This results in a more uniform introduction of force on all bolts, and hence in an improved force distribution, higher load capacity and greater safety.

In an embodiment, each possible combination of a half-round notch in the retaining element and/or in the outer component with a round notch in the outer and/or in the inner component represents a connection option when joining together two structural elements, and hence a possibility for tolerance compensation.

In an embodiment, the tolerance compensation component further encompasses at least one fastener. The fastener can encompass two fixators. One fixator is a pin, a bolt, a rivet, a screw and/or the like, for example. The fastener can be inserted into two notches aligned by means of the retaining element, the outer and/or inner component (one round each and one half-round), so as to secure the retaining element, the outer and/or inner component against further turning. In this way, the structural elements to be joined together are also locked to prevent any further movement relative to each other.

In an embodiment, the inner component exhibits essentially round notches, which are situated next to each other along a circular arc spaced a specific distance apart from the edge and midpoint of the inner component. The number X of round notches can lie between 1 and 5, for example. The number X of round notches can determine a fine adjustment of the tolerance compensation component.

The outer component can exhibit essentially half-round notches, which are situated next to each other along the circumference of the eccentric recess. The number R of half-round notches can lie between 15 and 25, for example. The number R of half-round notches can determine an overall size and rough adjustment of the tolerance compensation component.

A multiplication of the number R of half-round notches and the number X of round notches can correspond to a maximum quantity N1 of fastening positions for the retaining element, the outer and/or inner component relative to each other.

Additionally or alternatively, the outer component can also exhibit round notches, which are situated next to each other along a circular arc spaced a specific distance apart from the edge and midpoint of the outer component. The number W of round notches can lie between 1 and 5, for example. The number W of round notches can determine a fine adjustment of the tolerance compensation component.

The retaining element can in turn exhibit essentially half-round notches, which are situated next to each other along the circumference of the central recess of the retaining element. The number Z of half-round notches can lie between 15 and 25, for example. The number Z of half-round notches can determine an overall size and rough adjustment of the tolerance compensation component.

A multiplication of the number Z of half-round notches and the number W of the round notches can correspond to a maximum quantity N2 of fastening positions for the retaining element, the outer and/or inner component relative to each other.

A multiplication of the two maximum quantities N1 and N2 yields the maximum number of fastening points for the tolerance compensation component.

In an embodiment, the tolerance compensation component further encompasses at least one securing device, which secures the fastening means against falling out. The securing device can be disk-shaped, for example.

In an embodiment, the tolerance compensation component further encompasses at least one locking element, which secures the inner and/or outer component against axially moving relative to each other and/or relative to the retaining element. The locking element can encompass one locking unit each for securing the inner and outer component. Such a locking unit can be a snap ring or the like, for example.

In an embodiment, the retaining element is secured against turning relative to at least one of the structural elements to be joined together by a polygonal outer circumference, a projection, a cutout, an additional fastener and/or the like. For example, the polygonal outer circumference can be a hexagon. The projection can be a protruding lug, for example. The cutout can be a hollow space in the retaining element, for example. The additional fastener can be a screw and/or the like.

It is further proposed that an arrangement for tolerance compensation be provided when joining together two structural elements. The tolerance compensation arrangement encompasses a first structural element and at least one tolerance compensation component as described above, wherein the tolerance compensation component is attached to the first structural element. The structural elements can be scaffolds, frames, carriers, etc., e.g., from the area of aerospace.

In an embodiment, the tolerance compensation arrangement further encompasses an anchor element, wherein the anchor element is fastened to the tolerance compensation component on the one hand, and to a second structural element on the other.

In an embodiment, one of the two structural elements is a frame element for attachment to an aircraft or spacecraft. In an embodiment, the other of the two structural elements is a freight system for the aircraft or spacecraft.

It is further proposed that there be provided an aircraft or spacecraft with two structural elements to be joined together and at least one tolerance compensation component as described above for tolerance compensation when joining together these two structural elements.

It is further proposed that an assembly method be provided for a tolerance compensation component. The assembly method encompasses the following steps, not necessarily in this sequence:
a) Arranging an outer component in a recess of a retaining element.
b) Arranging an inner component in a recess of the outer component.

The inner and outer component each exhibit a recess eccentrically situated relative to the midpoint of the respective component. The circumference of the recess of the retaining element and/or the outer component exhibits half-round notches. The outer and/or inner component exhibits round notches, which are arranged like a circular arc on the inner and/or outer component.

In an embodiment, the outer component is secured in the recess of the retaining element, and the inner component is secured in the recess of the outer component by a respective or shared locking element. The locking element can be a snap ring or the like, for example.

In an embodiment, the assembly method further encompasses the following steps, not necessarily in this sequence:
c) Turning the retaining element, the outer and/or inner component until two notches are aligned.
d) Introducing a fastener into the two notches, so as to secure the retaining element, the outer and/or inner component against further turning.

The fastener can be a pin, a bolt, a rivet, a screw and/or the like, for example. The fastener is thus inserted into two aligned notches (one round and one half-round each), so as to secure the retaining element, the outer and/or inner component against further turning. In this way, the structural elements to be joined together are also locked to prevent any further movement relative to each other.

In an embodiment, the assembly method further encompasses attaching a securing device, which secures the fastener against falling out and/or detaching. The securing device can be a disk with an outer diameter large enough to cover the fastener in each set position of the tolerance compensation component, for example. Such a disk can be attached by means of a screw or nut.

### BRIEF DESCRIPTION OF THE DRAWINGS

Additional features, advantages and possible applications for the present invention may be gleaned from the following description of the exemplary embodiments and figures. All described and/or graphically illustrated features here comprise the subject matter of the invention, whether taken in isolation or in any combination, regardless of their composition in the individual claims or back references thereto. The same reference numbers on the figures stand for identical or similar objects.

FIG. 1 shows an exploded view of a tolerance compensation component.

FIG. 2 shows top views of the inner and outer component of a tolerance compensation component.

FIG. 3 shows top views of the outer component and retaining element of the tolerance compensation component.

FIG. 4 shows the effective range of the tolerance compensation component.

FIGS. 5a-5c show three-dimensional views of the tolerance compensation component.

FIG. 6 shows three-dimensional views of a tolerance compensation arrangement.

FIG. 7 shows two views of a tolerance compensation arrangement.

FIG. 8 in this regard shows a kinematic chain consisting of a swing arm and two push rods.

FIG. 9 shows an assembly method for a tolerance compensation component.

### DETAILED DESCRIPTION

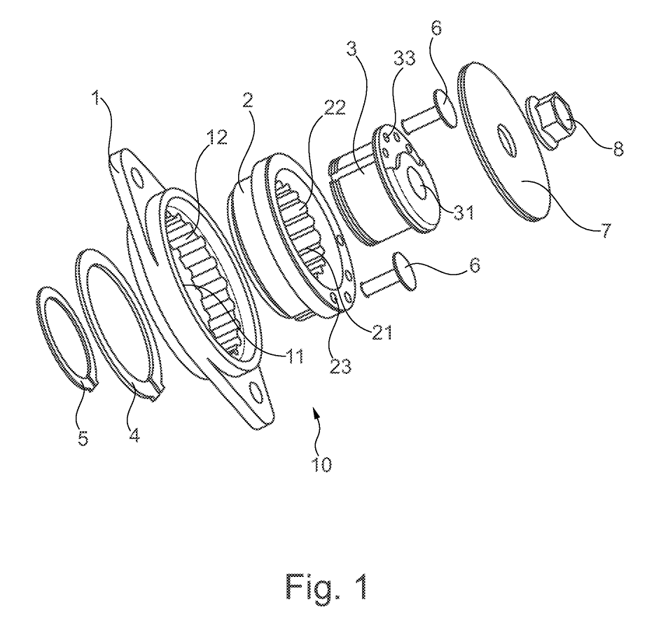

FIG. 1 shows an exploded view of a tolerance compensation component 10. The tolerance compensation component 10 encompasses a retaining element 1, an outer component 2, and an inner component 3.

In the examples shown on FIGS. 1 to 4, the retaining element 1 has a diameter of approx. 50 mm. Of course, any dimensions other than the dimensions shown are possible for the retaining element 1, outer component 2 and their respective recesses and notches. The number and arrangement of all notches can also be adjusted as desired to the intended purpose.

The retaining element 1 exhibits a central recess 11. The outer component 2 is arranged in the recess 11 of the retaining element 1. The outer component 2 exhibits a recess 21 eccentrically arranged relative to the midpoint of the outer component 2. The inner component 3 is in turn arranged in the recess 21 of the outer component 2. The inner component 3 also exhibits a recess 31 eccentrically arranged relative to the midpoint of the inner component 3.

The circumference of the recess 11 of the retaining element 1 and the circumference of the recess 21 of the outer component 2 exhibit essentially half-round notches 12, 22. The outer and/or inner component 2, 3 exhibit essentially round notches 23, 33, which essentially are arranged in a circular arc on the inner and/or outer component 2. These round notches 23, 33 are here only circular in an upper, collar-shaped part of the outer and/or inner component 2, 3. Below this collar or to the left thereof on FIG. 1, the notches 23, 33 are also only half-round in design. Therefore, the term “half round” must be understood to mean that the notches 23, 33 are half-round over at least a portion of their length.

The tolerance compensation component 10 also encompasses two fixators as fasteners 6. The fixators 6 are here two pins. The first fixator 6 is introduced into two notches (one round 23 and one half-round 12 each) that were aligned by turning the retaining element 1 and outer component 2. The second fixator 6 is introduced into two notches (one round 33 and one half-round 22 each) that were aligned by turning the outer component 2 and inner component 3. In this way, the retaining element 1, the outer and inner component 2, 3 are secured against further turning. In this way, the structural elements to be joined together are also locked to prevent any further movement relative to each other.

Each possible combination of a half-round notch in the retaining element 1 and/or in the outer component 2 with a round notch in the outer and/or inner component 3 represents a connection option when joining together two structural elements, and hence a possibility for tolerance compensation.

The tolerance compensation component 10 further encompasses at least one securing device 7, which secures the fixators 6 against falling out. The securing device 7 is here disk-shaped, and secures both fixators 6 together. The securing device 7 interacts with a nut 8.

The tolerance compensation component 10 further encompasses a locking element 4, which secures the outer component 2 against axially moving relative to the retaining element 1. The tolerance compensation component 10 further encompasses a locking element 5, which secures the inner component 3 against axially moving relative to the outer component 2. The locking elements 4, 5 are here snap rings. The locking elements 4, 5 prevent axial movement in one direction. In the opposite axial direction, the retaining element 1 and/or the two components 2, 3 can be secured against axial movement by a shoulder, projection or circumferential collar.

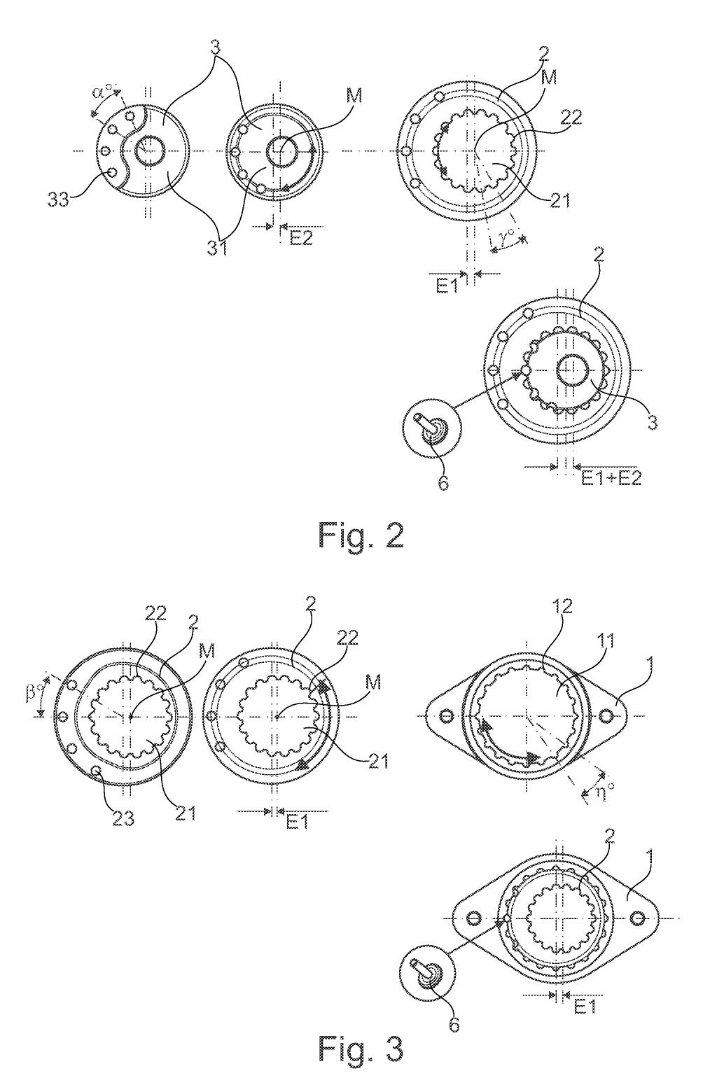

FIG. 2 shows top views of the inner and outer component 2 of a tolerance compensation component 10. The outer component 2 (right) exhibits a recess 21 eccentrically arranged relative to its midpoint. The distance between the midpoint of the outer component 2 and midpoint M of its eccentric recess 21 is referred to as eccentricity E1.

The inner component 3 is to be arranged in the recess 21 of the outer component 2. The inner component 3 (left) also exhibits a recess 31 eccentrically arranged relative to the midpoint of the inner component 3. The distance between the midpoint of the inner component 3 and the midpoint M of its eccentric recess 31 is referred to as eccentricity E2.

The outer component 2 exhibits half-round notches 22, which are arranged next to each other along the circumference of the eccentric recess 21. The angle between two vertices of the half-round notches lying next to each other measures γ. The number R of half-round notches 22 measures 360°/γ, here 18. The number R of half-round notches 22 determines the overall size and rough adjustment of the tolerance compensation component 10.

The inner component 3 exhibits circular notches 33, which are arranged next to each other along a circular arc spaced a specific distance away from the edge and midpoint of the inner component 3. The angle between two round notches 33 lying next to each other measures α. The number X of round notches here measures 4. The number X of round notches 33 can determine a fine adjustment of the tolerance compensation component 10. As a function of the angle γ between two vertices of half-round notches lying next to each other and the number X of round notches 33, angle α measures: α=γ/(1+(X−1)/X). This calculation represents just one of many possible calculations.

A multiplication of the number R of half-round notches 22 of the outer component 2 and the number X of round notches 33 of the inner component 3 yields a maximum quantity N1 of fastening positions for the outer and inner component 3 relative to each other, and hence of connection options when joining together two structural elements.

The tolerance compensation component 10 further encompasses at least one fixator 6. The fixator 6 is here a pin. The fixator 6 is introduced into two notches (one round and one half-round each) that were aligned by turning the outer and inner component 3, so as to secure the outer and inner component 3 against further turning. In this way, the structural elements to be joined together are also locked to prevent any further movement relative to each other.

Additionally or alternatively, the outer component 2 also exhibits round notches 23, which are arranged next to each other along a circular arc spaced a specific distance apart from the edge and midpoint of the outer component 2.

As shown on FIG. 3, the round notches 23 of the outer component 2 interact with half-round notches 12 of the retaining element 1. In this regard, FIG. 3 shows top views of the outer component 12 and the retaining element 1 of the tolerance compensation component 10. The retaining element 1 (right) exhibits a central recess 11. The outer component 2 is to be arranged in this recess 11 of the retaining element 1.

The retaining element 1 exhibits half-round notches 12, which are arranged next to each other along the circumference of the central recess 11. The angle between two vertices of the half-round notches lying next to each other measures η. The number Z of half-round notches 12 measures 360°/η, here 20. The number Z of half-round notches 12 determines an overall size and rough alignment of the tolerance compensation component 10.

The outer component 2 exhibits circular notches 23, which are arranged next to each other along a circular arc spaced a specific distance away from the edge and midpoint of the inner component 3. The angle between two round notches 23 lying next to each other measures β. The number W of round notches here measures 4. The number W of round notches 23 can determine a fine adjustment of the tolerance compensation component 10. As a function of the angle between two vertices of half-round notches lying next to each other and the number X of round notches 33, angle β measures: β=η/(1+(W−1)/W). This calculation represents just one of many possible calculations.

A multiplication of the number Z of half-round notches 12 of the retaining element 1 and the number W of round notches 23 of the outer component 2 yields a maximum quantity N2 of fastening positions for the retaining element 1 and outer component 2 relative to each other, and hence of connection options when joining together two structural elements.

Here as well, the tolerance compensation component 10 encompasses at least one fixator 6, specifically a pin. The fixator 6 is introduced into two notches (one round and one half-round each) that were aligned by turning the retaining element 1 and outer component 2, so as to secure the retaining element 1 and outer component 2 against further turning. In this way, the structural elements to be joined together are also locked to prevent any further movement relative to each other.

A multiplication of the two maximum quantities N1 and N2 yields the maximum number of fastening positions for the tolerance compensation component 10.

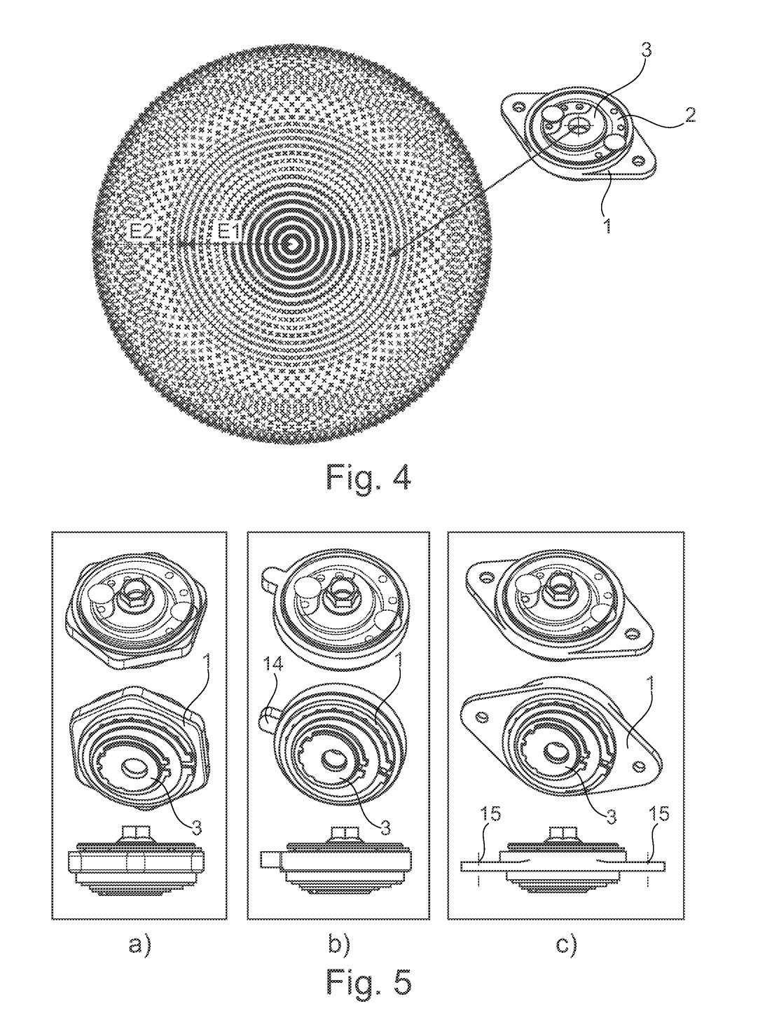

FIG. 4 shows the effective range of the tolerance compensation component 10 with the two respective exemplary eccentricity values E1 and E2 of 2.5 mm for both eccentric pairs. The tolerance compensation component 10 here enables X*R*Z*W=5760 fastening positions for the midpoint of the recess 31 of the inner component 3 within a circle having a radius of E1+E2=5 mm. The 5760 fastening positions are the product of multiplying the aforementioned two maximum quantities N1 and N2. The maximum distance between adjacent fastening positions here measures approx. 0.22 mm. Therefore, the roughest resolution measures 0.22/2=0.11 mm. The resolution is basically variable within the effective range of the tolerance compensation component.

FIGS. 5a-5c show three-dimensional views of the tolerance compensation component 10 with various embodiments for securing the retaining element 1 against turning relative to at least one of the structural elements to be joined together. In FIG. 5a, the retaining element 1 is secured by a polygonal outer circumference, here a hexagon. In FIG. 5b, the retaining element 1 is secured by a projection 14, here a protruding lug. In FIG. 5c, the retaining element 1 is secured by additional fasteners 15, here two screws.

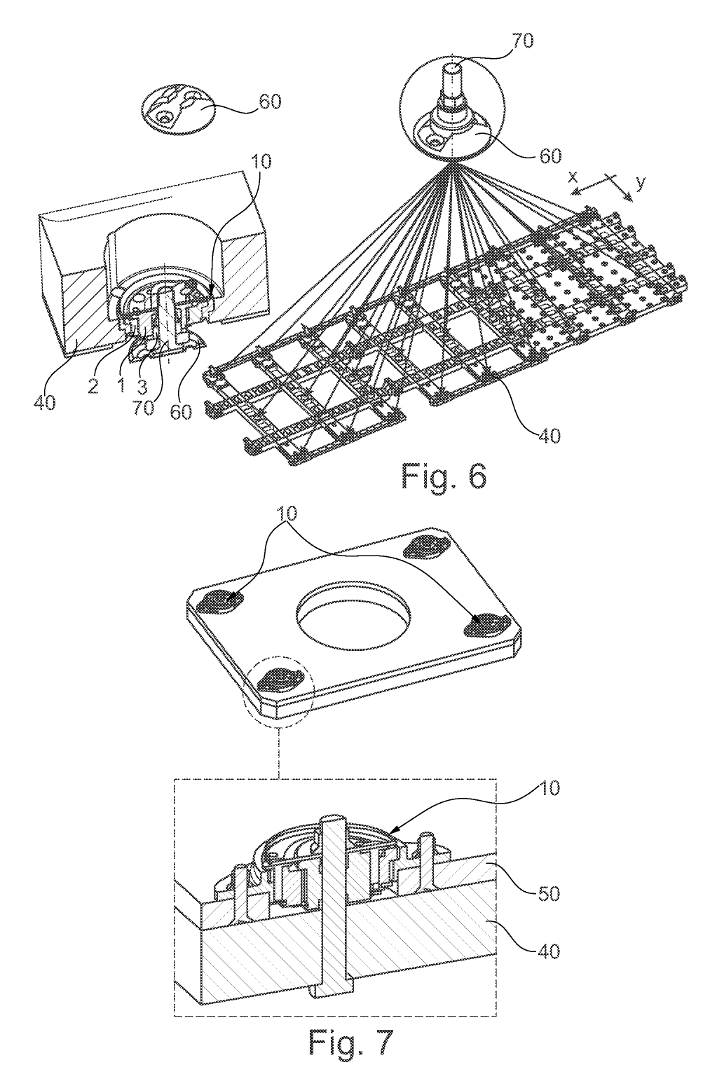

FIG. 6 shows three-dimensional views of an arrangement for tolerance compensation when joining together two structural elements 40. The tolerance compensation arrangement encompasses tolerance compensation components 10 as described above, and at least one first structural element 40. The first structural element 40 is here a frame element of a mobile freight loading unit to be attached to an aircraft or spacecraft, for example. The first structural element 40 is to be joined with a second structural element (not shown), e.g., which can be part of a floor in the cargo hold of an aircraft or spacecraft.

The tolerance compensation arrangement further encompasses anchor elements 60, which are to be attached to the second structural element (not shown). Connecting bolts 70 for connection with the first frame-shaped structural element 40 are inserted into the anchor elements 60. Tolerance compensation components 10 are inserted between the connecting bolts and first structural element 40 to achieve a tolerance compensation between the first and second structural elements, e.g., in the depicted x- and y-directions.

FIG. 7 shows two views of an arrangement for tolerance compensation. The tolerance compensation arrangement encompasses a first and second plate-shaped structural element 40, 50, which are joined together by four tolerance compensation components 10.

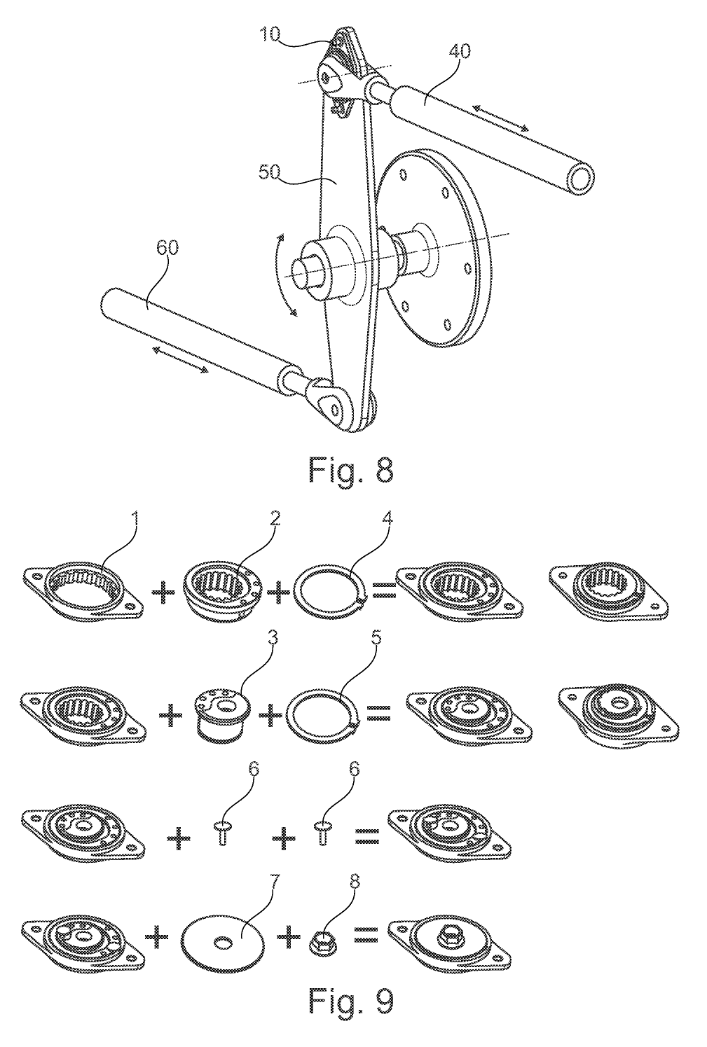

In addition to tolerance compensation, the tolerance compensation component 10 can also be used for setting or finely adjusting the structural elements to be joined together, i.e., for adjusting the radius, angle, position, etc. For this purpose, FIG. 8 shows a kinematic chain consisting of a swing arm 50 and two push rods 40, 60. The swing arm 50 and two push rods 40, 60 correspond to the structural elements to be joined together (three in this case). For example, they can be part of a kinematic chain.

Instead of setting or adjusting the kinematic chain by tightening or loosening the forks of at least one of the push rods 40, 60, for example, a tolerance compensation component 10 is here situated between one of the levers 40 and push rods 50. In this way, the tolerance compensation component 10 makes it possible to set and finely adjust the kinematic chain, and thereunder to set the effective lever radius of the swing arm 50.

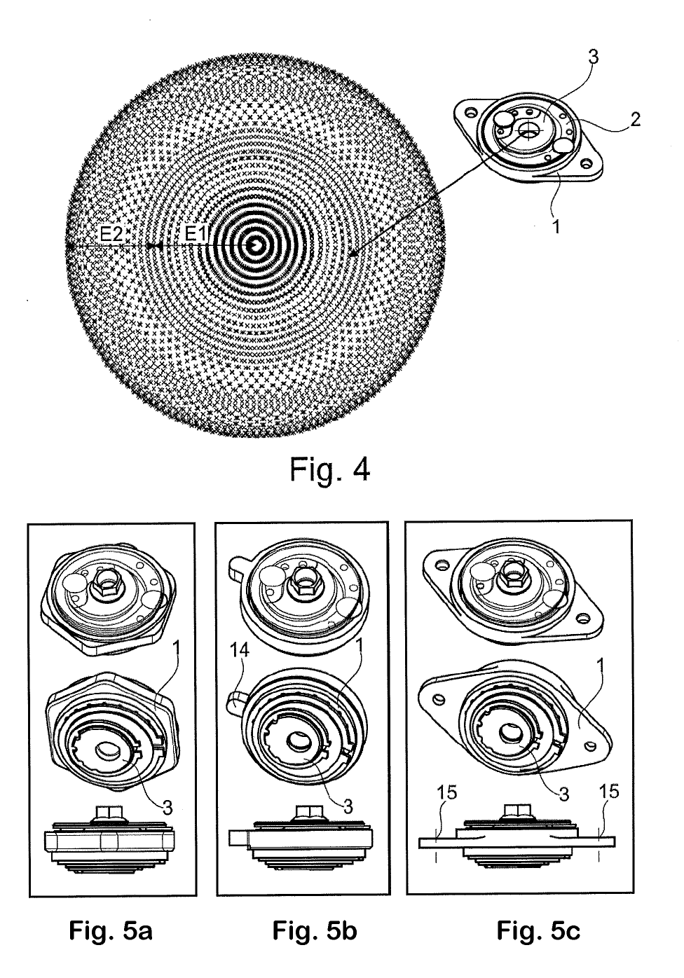

FIG. 9 shows an assembly method for a tolerance compensation component 10. The assembly method encompasses the following steps, not necessarily in this sequence:
a) Arranging an outer component 2 in a recess 11 of a retaining element 1 and securing it with a locking element 4.
b) Arranging an inner component 3 in a recess 21 of the outer component 2 and securing it with a locking element 5.
c) Turning the retaining element 1, the outer and/or inner component 3 until two notches 12, 23, 22, 33 are aligned.
d) Introducing a fastener 6 into the two notches 12, 23, 22, 33, so as to secure the retaining element 1, the outer and/or inner component 3 against further turning.
e) Attaching a securing device 7 with a screw element and nut element 8, which secures the fastener 6 against falling out.

The retaining element 1, outer component 2 and inner component 3 are here already joined hand tightened with each other in advance (see FIG. 9, first and second rows), which facilitates handling during installation. This even makes it easier to store and transport the tolerance compensation component(s), for example.

In addition, let it be noted that “encompassing” does not preclude any other elements or steps, and that “a” or “an” does not rule out a plurality. Let it further be noted that features or steps that were described with reference to one of the above exemplary embodiments can also be used in combination with other features or steps from other exemplary embodiments described above. Reference numbers in the claims are not to be construed as al imitation.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A tolerance compensation component for tolerance compensation while joining together first and second structural elements, the component comprising:
a retaining element;
an outer component; and
an inner component;
wherein the retaining element includes a recess, and the outer and inner component each includes a recess arranged eccentrically relative to the midpoint of the respective component,
wherein the inner component is situated in the recess of the outer component, and the outer component is situated in the recess of the retaining element,
wherein at least one of the circumference of the recess of the retaining element and the outer component includes half-round notches, and
wherein at least one of the outer and inner component includes round notches arranged in a circular arc on the corresponding one of the inner and outer components.

2. The tolerance compensation component of claim 1, further comprising at least one fastener configured to be inserted into two notches that were aligned by turning the retaining element, outer and/or inner component, so as to secure the retaining element, outer and/or inner component against further turning.

3. The tolerance compensation component of claim 1, wherein each possible combination of a half-round notch in the retaining element and/or in the outer component with a round notch in the outer and/or inner component represents a connection option when joining together the first and second structural elements, and hence a possibility for tolerance compensation.

4. The tolerance compensation component of claim 1, wherein the retaining element is secured against turning relative to at least one of the structural elements to be joined together by a polygonal outer circumference, a projection, a cutout or an additional fastener.

5. A tolerance compensation arrangement when joining together first and second structural elements, the arrangement comprising:
the first structural element; and
at least one tolerance compensation component attached to the first structural element, the tolerance compensation component comprising:
a retaining element;
an outer component; and
an inner component;
wherein the retaining element includes a recess, and the outer and inner component each includes a recess arranged eccentrically relative to the midpoint of the respective component,
wherein the inner component is situated in the recess of the outer component, and the outer component is situated in the recess of the retaining element, and
wherein at least one of the circumference of the recess of the retaining element and the outer component includes half-round notches,
wherein at least one of the outer and inner component includes round notches arranged in a circular arc on the corresponding one of the inner and outer components.

6. The tolerance compensation arrangement of claim 5, further comprising an anchor element, wherein the anchor element is attached to the tolerance compensation component on the one hand, and to a second structural element on the other.

7. The tolerance compensation arrangement of claim 5, wherein the first or second structural element is a frame element for attachment to an aircraft or spacecraft, and wherein the second or first structural element is part of a freight system for the aircraft or spacecraft.

8. An assembly method for a tolerance compensation component, comprising:
arranging an outer component in a recess of a retaining element; and
arranging an inner component in a recess of the outer component,
wherein the outer and inner component each includes a recess eccentrically situated relative to the midpoint of the respective component,
wherein at least one of the circumference of the recess of the retaining element and the outer component includes half-round notches, and
wherein at least one of the outer and inner component includes round notches arranged like a circular arc on the corresponding one of the inner and outer components.

9. The assembly method of claim 9, further comprising:
turning the retaining element, the outer and/or inner component until two notches are aligned; and
introducing a fastener into the two notches, so as to secure the retaining element, the outer and/or inner component against further turning.
